(19) United States
(12) Patent Application Publication
(10) Pub. No.: US 2010/0309657 A1
(43) Pub. Date: Dec. 9, 2010

(54) USB memory device with integrated flashlight

(76) Inventors: Beverly Purdy, San Jose, CA (US); Craig A. Purdy, Campbell, CA (US); Christine Marquez, Campbell, CA (US)

Correspondence Address: CHRISTINE MARQUEZ, 320 Payne Ave, Campbell, CA, 95008, US

(21) Appl. No.: 12/455,655

(22) Filed: Jun. 4, 2009

(51) Int. Cl. F21L 4/00; F21V 33/00

(52) U.S. Cl. 362/200; 362/253

(57) ABSTRACT

The present invention combines a USB memory device with flashlight to conveniently illuminate a computer USB port for easier insertion of the USB plug. The flashlight can be used independently from the USB memory device to illuminate any dark area. The light is integrated with the USB flash drive, battery powered, bright and focused through a housing which directs the light beam to the front end of the device. The assembly contains a printed circuit board (PCB) including LED bulbs which indicate operational status. The embodiment of the invention includes a removable cap that protects the USB plug and also has a feature which permits the light to pass through for flashlight use. The components are designed in a manner that utilizes physical features to interlock and contain the assembly.

### BACKGROUND OF THE INVENTION

1. Field of the Invention

The invention consists of combining a USB memory device (flash drive, flash memory, thumbdrive, USB stick) with an integrated flashlight to conveniently illuminate a computer USB port for easier insertion. The flashlight can also be used independently from the USB memory device for illuminating any dark area.

2. Description of the Prior Art

There are a variety of USB memory devices as well as different name usage such as flash drive, thumbdrive, and USB stick. There are also a variety of shapes, color, size and memory storage amounts made by a number of companies such as SanDisk, Kingston, Memorex, etc. The devices can be made out of plastic, metal, wood, and there is one shaped as a pen. Another has a LED light to illuminate a company logo. Or a light is used to show a good connection.

For example, U.S. Pat. No. US 2008/0316697 A1 to Zhu shows a flash memory device with improved light-guide member and cover thereof to absorbs the light of the LED light in order to averagely illuminate an area of the cover to be illuminated such as a company logo.

U.S. Pat. No. 6,773,192 B1 (2004) to Chao shows a light-emitting USB mobile disk-pen uses an LED at the PCB to emit light via a bulb at the upper pen shaft, and thereby preventing poor contact quality of the USB plug.

U.S. Pat. US 2008/0261449 A1 to Ni et al. shows a flash drive housing a slim USB device and having swivel cap functionalities allowing for two locking positions.

U.S. Pat. No. 6,894,864 B2 to Chang et al. shows a portable storage device with a lamp portion for showing the operating status.

The placement of computers varies and many times it is difficult to view where the computer port is when trying to insert the USB flash drive, as well as distinguish which way to insert it. It is desired to combine a flash memory device with an integrated flashlight which is the inspiration for this invention.

### BRIEF SUMMARY OF THE INVENTION

A USB flash memory device and integrated flashlight disclosed in the preferred embodiment of the present invention includes a PCB with a USB flash drive, a top and bottom shell, a light housing, a LED light, batteries which are the energy source for the light, and a removable cover which protects the USB plug. The top shell contains a button to activate the light, a window to show operational status. Screws keep the device together and provide easy access for changing batteries and light bulb when needed.

The primary object of the invention is to combine a USB memory device and a flashlight in a ergonomic enclosure so that the light housing which contains and orients a bulb, focuses a bright light to the front of the USB flash memory device, conveniently illuminating the computer port for easier insertion of the USB plug. The flashlight can be used independently from the USB memory device to illuminate any dark area.

Other objects, advantages and novel features of the present invention will become more apparent from the following detailed description of the preferred embodiment when taken in conjunction with the accompanying drawings.

### BRIEF DESCRIPTION OF THE DRAWINGS

Specific embodiments of the invention along with other objects and advantages included in the present invention will be apparent from the following description taken in connection with the accompanying illustrations, in which:

FIG. 1 is an elevated top view of the flash memory device and integrated flash light showing the present invention;

FIG. 2 is an exploded elevation top view of a flash memory device and integrated flash light according to the preferred embodiment of the present invention;

FIG. 3 is an elevated top view of the flash memory device and integrated flash light showing the present invention with side rails rather than the conventional top button to turn on and off light source;

FIG. 3A is an elevated top view of the flash memory device and integrated flash light showing the present invention with a rotating knob rather than the conventional top button to turn on and off light source;

FIG. 3B is an elevated top view of the flash memory device and integrated flash light showing the present invention with a slide switch rather than the conventional top button to turn on and off light source;

FIG. 4 is an elevated top view of the flash memory device and integrated flash light showing the present invention with an optional switch to lock-on light source;

FIG. 5 is an elevated top view of the flash memory device and integrated flash light showing the present invention with a rectangular shaped light housing, wherein the light that is emitted from the device would cast a rectangular shape by the USB plug;

FIG. 5A is an elevated top view of the flash memory device and integrated flash light showing the present invention with fiber optic light housing which forms an annular ring around the USB plug, wherein the light emitted from the device would light up all around the USB plug;

FIG. 5B is an elevated top view of the flash memory device and integrated flash light showing the present invention with a twin light housing, wherein, two lights would emit from the sides of the device casting light on both sides of the USB plug.

### DETAILED DESCRIPTION OF THE INVENTION

Reference will now be made in detail to the preferred embodiment of the present invention.

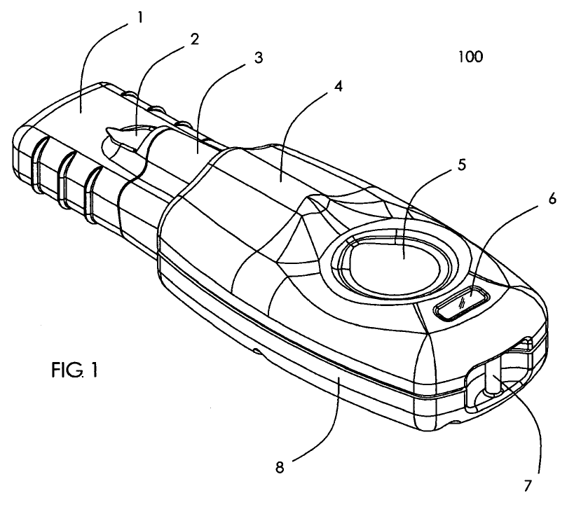

Referring to FIGS. 1 to 3, a combined flash memory device with integrated flash light 100 includes a removable cap 1 with a light guiding feature 2 for flashlight use, a light housing 3 with interlocking grooves 16, a rectangular cut-out 31 for the USB plug with printed circuit board (PCB) 10 to slide into. The PCB has a feature 15 that positions and anchors it to the light housing 3. Side indents 32 accept bosses 81 from the top and bottom shells 4 and 8. A circular bore 33 houses a bulb 9 which is powered by batteries 11. LED lights 13 are on the PCB to show operational status of the memory device. The top and bottom shells have bosses on the side walls near front 14 which accept interlocking grooves from light housing 16. Through holes 83 in the bottom shell 8 accept screws 12 to fasten the top and bottom shells 4 and 8 together. The bottom shell 8 has a post 7 to accommodate a lanyard. The top cover 4 has a contoured surface with a button 5 to activate the flashlight and a window 6 to show the operational status of the memory device.

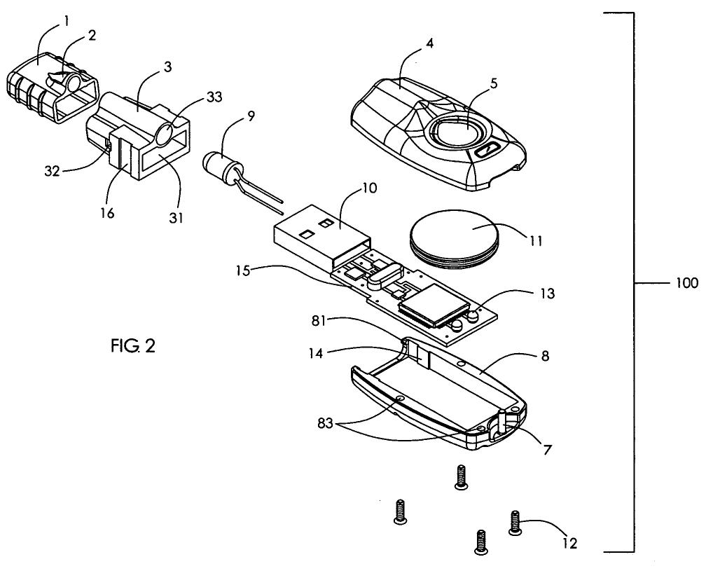

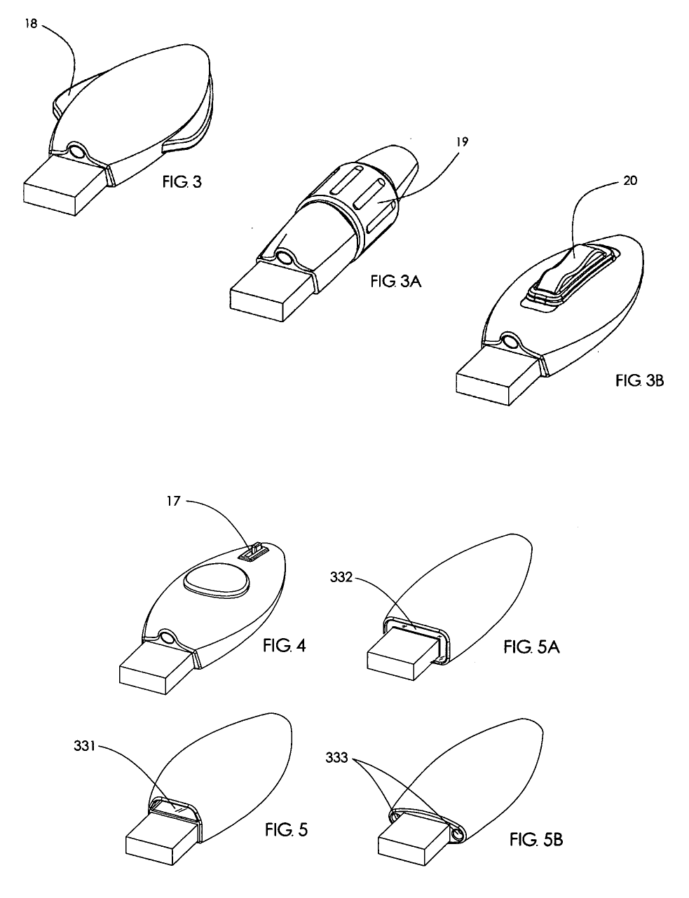

The flash memory device with integrated flashlight 100 can have options to turn on and off the light source shown in FIGS. 3, 3A and 3B. FIG. 3 shows side buttons 18, FIG. 3A shows a rotating knob 19, and FIG. 3B shows a slider 20.

The flash memory device with integrated flashlight 100 can have an optional switch 17 to lock-on the flashlight for continual use shown in FIG. 4.

The flash memory device with integrated flashlight 100 can have different light housing configurations shown in FIGS. 5, 5A and 5B. In FIG. 5 the light source is shown to be rectangular 331. In FIG. 5A the light source is shown with fiber optics bundled into an annular ring around the USB plug 332. FIG. 5B illustrates twin light sources is located on the sides of the invention body 333.

Numerous modifications and variations of the present invention are possible as described and illustrated without departing from the spirit or scope of the invention. The objects set for the above, descriptions and drawings shown shall be interpreted as illustrative and not in a limited sense—changes may be made in details, especially in matter of shape size, arrangement of parts, and fittings. It is therefore to be understood that, within the scope of the appended claims, the invention may be practiced otherwise than as specifically described herein.

We claim:

1. A flash memory device and integrated flashlight, comprising:
a USB memory device with lights on the PCB which indicate the operational status;
a light housing which accommodates a light source as well as features that engage and interact with other components in the assembly such as grooves, channels, bosses snaps, etc.;
a top and bottom shell which enclose and protect the components, give the device a clean and attractive appearance and provide an ergonomic means of activating the flashlight. The top and bottom covers also contain features that engage and interact with other components in the assembly such as grooves, channels, bosses snaps, etc.;
the device also contains batteries, screws; and
a protective cap which covers the USB plug.
When activated a bright focused light is directed in front of the flash memory device so the computer port is illuminated for easier insertion of the USB plug. The flashlight can also be used independently from the USB memory device for illuminating any dark area.

2. A flash memory device and integrated flashlight according to claim 1, wherein the removable cap has a light guiding feature to direct light when using the device as a flash light only.

3. A flash memory device and integrated flashlight according to claim 1 wherein the light housing has a rectangular cut-out to position and anchor USB plug with PCB.

4. A flash memory device and integrated flashlight according to claim 1 wherein the light housing unit has a circular bore to accommodate a light bulb

5. A flash memory device and integrated flashlight according to claim 1 wherein the bulb in the light housing is powered by batteries.

6. A flash memory device and integrated flashlight according to claim 1 wherein the light housing includes features that engage and interact with other components in the assembly such as grooves, channels, bosses snaps, etc.;

7. A flash memory device and integrated flashlight according to claim 1 wherein the top and bottom shells include features that engage and interact with other components in the assembly such as grooves, channels, bosses snaps, etc.;

8. A flash memory device and integrated flashlight according to claim 1 wherein the housing contains a button or switch to activate the light which can be active or passive, meaning can have a spring return or simply used the inherent material properties such as flex or elasticity to function.

9. A flash memory device and integrated flashlight according to claim 1 wherein the housing provides a window to show operational status of the USB memory device.

10. A flash memory device and integrated flashlight according to claim 1 wherein the housing contains a feature which allows the user to activate the light source means button can be joined with a switch allowing the light to be locked on or only activated with each press of the user's thumb.

11. A flash memory device and integrated flashlight according to claim 1 wherein the button can also be located on the sides and activated by squeezing the body rather than pressing an area on the top or bottom, or can be twisted to turn on and off, or can be slid back and forth or side to side to activate the light.

12. A flash memory device and integrated flashlight according to claim 1 wherein the light housing can be different shapes depending on bulb shape or color or type of lighting used.

13. A flash memory device and integrated flashlight according to claim 1 wherein the housing contains a post to accommodate a lanyard to hang from or connect to a key chain, etc.

14. A flash memory device and integrated flashlight according to claim 1 wherein the PCB can be made to accommodate any size, capacity USB memory card i.e. 256 MB, 2 GB, 16 GB, etc.

15. A flash memory device and integrated flashlight according to claim 1 wherein the USB Plug is facing properly so as to distinguish top from bottom for easier insertion.

16. A flash memory device and integrated flashlight according to claim 1 wherein the thumbdrive that is combined with the light can have a protective cap, or can be made retractable to protect it when not inserted into the computer port. Or flipped out like a fold up knife.
